(19) United States
(12) Patent Application Publication
(10) Pub. No.: US 2020/0225472 A1
(43) Pub. Date: Jul. 16, 2020

(54) VEHICLE DISPLAY DEVICE

(71) Applicant: YAZAKI CORPORATION, Tokyo (JP)

(72) Inventor: Kunimitsu Aoki, Shizuoka (JP)

(21) Appl. No.: 16/835,463

(22) Filed: Mar. 31, 2020

Related U.S. Application Data
(63) Continuation of application No. PCT/JP2018/031766, filed on Aug. 28, 2018.

(30) Foreign Application Priority Data
Oct. 26, 2017 (JP) 2017-207323

(51) Int. Cl. G02B 27/01; B60K 35/00

(52) U.S. Cl. CPC G02B 27/0149; G02B 27/0101; B60K 35/00; B60K 2370/1529; B60K 2370/167; B60K 2370/178; G02B 2027/0159

(57) ABSTRACT

A vehicle display device includes: an emitting part that is mounted in a vehicle and emits a display light; a housing that accommodates the emitting part in an inner accommodation space; and a last mirror that reflects the display light emitted from the emitting part toward a windshield provided in a front of the vehicle in a vehicle front-back direction and causes the windshield to reflect the display light toward a presumed eye point. The windshield has a rising angle on a side of the eye point relative to a horizontal direction of equal to or greater than 60° and equal to or less than 90°. The last mirror is provided outside the accommodation space as a whole, and is located between the windshield and the eye point EP in the vehicle front-back direction and opposed to the windshield.

### CROSS-REFERENCE TO RELATED APPLICATION

This application is a continuation application of International Application No. PCT/JP2018/031766 filed on Aug. 28, 2018 which claims the benefit of priority from Japanese Patent Application No. 2017-207323 filed on Oct. 26, 2017 and designating the U.S., the entire contents of which are incorporated herein by reference.

### BACKGROUND OF THE INVENTION

### 1. Field of the Invention

The present invention relates to vehicle display devices.

### 2. Description of the Related Art

Japanese Patent Application Laid-open No. H11-321383 discloses a head-up display for work vehicles as a conventional vehicle display device, for example. Such a head-up display has a combiner on a transparent member ahead of a driver's seat and projects light information onto this combiner. The combiner of the transparent member is provided at a constant length across a left-right virtual center line of this transparent member, and this head-up display displays a marker for guiding a straight run onto this combiner.

It would be desirable for the head-up display in Patent Document 1 described above to be configured to display an image on a windshield appropriately even if it is applied to, for example, work vehicles where the windshield rises at a predetermined angle relative to a horizontal direction.

### SUMMARY OF THE INVENTION

The present invention is made in view of the above situation, and its object is to provide a vehicle display device that performs displaying by a display light appropriately on the windshield rising from the horizontal direction.

In order to achieve the above mentioned object, a vehicle display device according to one aspect of the present invention includes an emitting part that is mounted in a vehicle and emits a display light; a housing that accommodates the emitting part in an inner accommodation space; and a last mirror that reflects the display light emitted from the emitting part toward a windshield provided in a front of the vehicle in a vehicle front-back direction and causes the windshield to reflect the display light toward an presumed eye point, wherein the last mirror is provided outside the accommodation space as a whole, and is located between the windshield and the eye point in the vehicle front-back direction and opposed to the windshield, the housing has an optical-path aperture that leads, to an outside of the accommodation space, the display light from an inside of the accommodation space toward the last mirror, and the vehicle display device further includes: an aperture-opening/closing driver that allows the last mirror to move to a display position where the last mirror is located between the windshield and the eye point and opposed to the windshield in the vehicle front-back direction, reflects the display light emitted from the emitting part toward the windshield on the front side in the vehicle front-back direction, and causes the windshield to reflect the display light toward the eye point, and a non-display position where the last mirror blocks the optical-path aperture.

According to another aspect of the present invention, in the vehicle display device, it is possible to include that a meter part that is located between the windshield and the eye point in the vehicle front-back direction and displays vehicle information about the vehicle visibly at the eye point, wherein the last mirror is located between the windshield and the meter part in the vehicle front-back direction and provided on a surface on the front side in the vehicle front-back direction of the meter part.

According to still another aspect of the present invention, in the vehicle display device, it is possible to configured that the windshield has a rising angle on a side of the eye point relative to a horizontal direction of equal to or greater than 60° and equal to or less than 90°.

According to still another aspect of the present invention, in the vehicle display device, it is possible to further include that a display-position adjuster that rotates the last mirror, around a rotary-axis line along a vehicle width direction crossing the vehicle front-back direction as a rotation center, to adjust a reflection angle of the display light reflected on the last mirror toward the windshield and adjust a display position by the display light reflected on the windshield toward the eye point.

According to still another aspect of the present invention, in the vehicle display device, it is possible to further include that the last mirror reflects the display light emitted from the emitting part toward the front side in the vehicle front-back direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a schematic configuration of a vehicle display device according to a first embodiment and a windshield of a vehicle to which the vehicle display device is applied.

FIG. 2 is a schematic diagram illustrating a schematic configuration of the vehicle display device according to the first embodiment.

FIG. 3 is a schematic diagram illustrating a schematic configuration of a vehicle display device according to a second embodiment and a windshield of a vehicle to which the vehicle display device is applied.

FIG. 4 is a schematic diagram illustrating a schematic configuration of the vehicle display device according to the second embodiment.

FIG. 5 is a schematic diagram illustrating a schematic configuration of a vehicle display device according to a variation.

FIG. 6 is a schematic diagram illustrating an operation of the vehicle display device according to the variation.

FIG. 7 is a schematic diagram illustrating an operation of the vehicle display device according to the variation.

### DETAILED DESCRIPTION OF THE PREFERRED EMBODIMENTS

Embodiments according to the present invention will now be described in detail based on the drawings. Note that this invention is not limited by these embodiments. Components in the following embodiments include that whose substitution by one skilled in the art is possible and easy, or substantially the same as those.

### First Embodiment

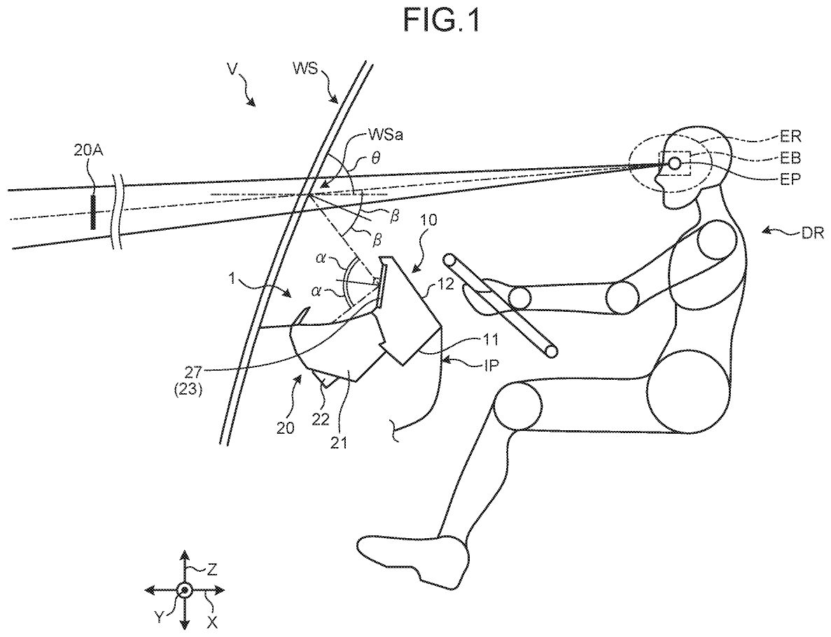

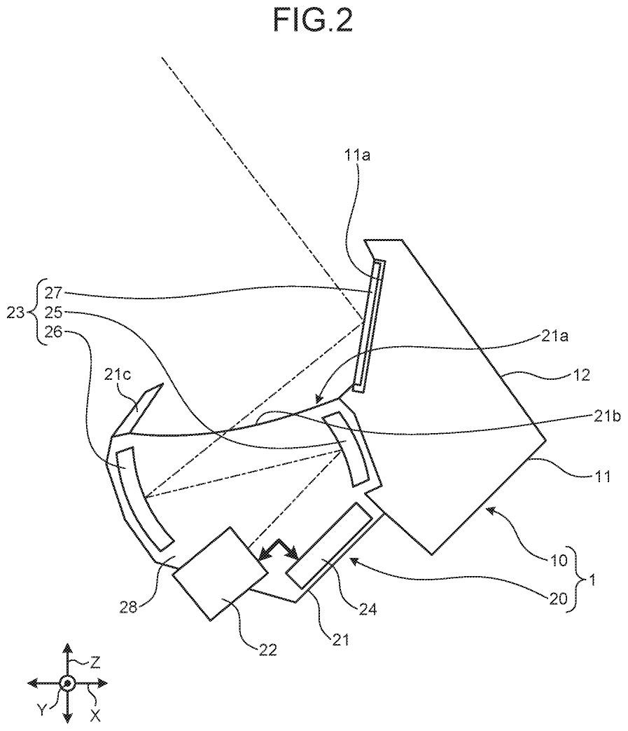

A vehicle display device 1 according to the present embodiment shown in FIG. 1 and FIG. 2 is applied to a vehicle V. For example, the vehicle display device 1 is mounted in an instrument panel IP on a dashboard of the vehicle V. The vehicle display device 1 presents various pieces of visual information to a driver DR and other occupants via an image 20A obtained by emitting a display light toward a windshield WS of the vehicle V and reflecting it on the windshield WS toward an eye point EP. Here, the instrument panel IP is an interior member provided in the vehicle V inside a vehicle room with a driver's seat and other components and on the front side in a vehicle front-back direction. The instrument panel IP extends along a vehicle width direction Y. Typically, the eye point EP is presumed that it is located in an eye box EB set within what is called an eye range ER in the vehicle V. The eye range ER is an “automobile-driver's eye range” and is equivalent to an area where a viewpoint of the driver DR predetermined depending on the vehicle V is located. Typically, the eye range ER statistically represents the positional distribution of a driver DR's eye in the vehicle V and, for example, is equivalent to an area where the position of the driver DR's eye is included at a predetermined percentage (e.g., 95%) with the driver DR sat in the driver's seat. The eye box EB is located in the eye range ER and presumed as a spatial area where the driver DR can view the image 20A appropriately while the driver DR performs driving in a condition where he/she sits in the driver's seat. The windshield WS is an optically transparent, clear member that transmits at least a light of a visible-light-range component (visible ray). Here, the light of the visible-light-range component is a light of a wavelength component in the visible-light range visible to humans, and, for example, is a light of a wavelength component ranging from 360 to 830 nm. The windshield WS is provided in the front of the vehicle V in the vehicle front-back direction X and is also referred to what is called a wind screen.

The windshield WS of the vehicle V to which the vehicle display device 1 of the present embodiment is applied has, with the vehicle V located on a horizon plane, a rising angle θ on the side of the eye point EP relative to its horizontal direction of equal to or greater than 60° and equal to or less than 90° (60°≤θ≤90°). The vehicle display device 1 of the present embodiment is configured to display the image 20A by the display light appropriately on the windshield WS rising from the horizontal direction in this way.

Note that the vehicle V to which the vehicle display device 1 of the present embodiment is applied to is typically work vehicles, such as agricultural-machine vehicles (e.g., tractors), construction-machine vehicles (e.g., crane vehicles and shovel vehicles), cleaning vehicles (e.g., road-surface-cleaning vehicles), and transportation vehicles (e.g., dump vehicles and trucks), but is not limited to these vehicles. As long as the rising angle θ of the windshield WS is equal to or greater than 60° and equal to or less than 90° as described above, the vehicle V may be, for example, buses or general cars. As long as the rising angle θ of the windshield WS is equal to or greater than 60° and equal to or less than 90° as described above, the vehicle V may be railroad vehicles without being limited to automobiles.

In the following description, in the vehicle V to which the vehicle display device 1 is applied, the “vehicle front-back direction X” is typically equivalent to an overall-length direction of the vehicle V and furthermore is equivalent to a direction along the front-back straight direction of the vehicle V. Typically, the “vehicle width direction Y” is equivalent to an overall-width direction of the vehicle V and is typically equivalent to a left-right direction of the vehicle V. Typically, the “vehicle height direction Z” is equivalent to the height direction of the vehicle V. The vehicle front-back direction X, which is a first direction, the vehicle width direction Y, which is a second direction, and the vehicle height direction Z, which is a third direction, are perpendicular to each other. With the vehicle V located on the horizon plane, the vehicle front-back direction X and the vehicle width direction Y are along the horizontal direction, and the vehicle height direction Z is along a vertical direction. In the following description, in the vehicle front-back direction X, the side where the vehicle V moves forward may be referred to as the “front” and the side where the vehicle V moves backward may be referred to as the “back”. In the vehicle width direction Y, the left side toward the front in the vehicle front-back direction X may be referred to as the “left side” and the right side toward the front in the vehicle front-back direction X may be referred to as the “right side”. In the vehicle height direction Z, the upper side in the vertical direction may be referred to as the “upper side” and the lower side in the vertical direction may be referred to as the “lower side”. Each direction used in the following description shall represent a direction in a condition where respective parts are mutually assembled, unless otherwise specified. A configuration of the vehicle display device 1 will now be described in detail with reference to the figures.

Specifically, as shown in FIG. 1 and FIG. 2, the vehicle display device 1 of the present embodiment includes a meter part 10 and a head-up display (HUD) part 20 (hereinafter may be referred to as an “HUD part”). The vehicle display device 1 is a display device unit where the meter part 10 and the HUD part 20 are integrated and unitized.

The meter part 10 is located between the windshield WS and the eye point EP in the vehicle front-back direction X and is a part that displays vehicle information about the vehicle V visibly at the eye point EP. For example, the meter part 10 is configured by installing, into a meter housing 11, an analog-type instrument, a digital-type instrument, a display, a direction-instruction display part, a shift position indicator, various warning lights, and other components. In the meter part 10, a surface on the opposed side to the eye point EP in the vehicle front-back direction X of the meter housing 11, that is to say, a surface on the back side in the vehicle front-back direction X constitutes a meter display part 12. The meter part 10 displays, on the meter display part 12, various kinds of vehicle information offered for driving of the vehicle V. The vehicle information displayed on the meter part 10 may include, for example, the speed of the vehicle, the output rotational speed of a power source for traveling, an accumulated mileage, a cooling-water temperature, a fuel residual quantity, a battery storage quantity, various warning lights (warning lamps, what is called telltales), a shift position, a direction instruction direction, and navigation information. The meter part 10 is installed into the instrument panel IP in a position relation where the meter display part 12 is opposed and exposed to the eye point EP in the vehicle front-back direction X.

The HUD part 20 is located between the windshield WS and the eye point EP in the vehicle front-back direction X, and is a part that displays vehicle information about the vehicle V visibly at the eye point EP via the image 20A reflected in the windshield WS. More particularly, the HUD part 20 is located between the windshield WS and the meter housing 11 of the meter part 10 in the vehicle front-back direction X. The HUD part 20 emits the display light to the windshield WS and displays, on the windshield WS, the image 20A by the display light reflected on the windshield WS toward the eye point EP. As described above, the vehicle information displayed by the HUD part 20 may include, for example, the speed of the vehicle, the output rotational speed of the power source for traveling, an accumulated mileage, a cooling-water temperature, a fuel residual quantity, a battery storage quantity, various warning lights, a shift position, a direction instruction direction, and navigation information, as well as various signs and figures displayed by superimposing them on a background seen over the windshield WS from the eye point EP. The vehicle information displayed by the HUD part 20 may include, for example, as information that is intuitive and gives no inconvenience, attention-object information around the vehicle V represented by a figure having a relatively simplified form that is easy to be intuitively identified by, for example, occupants (e.g., information about pedestrians, peripheral vehicles, obstacles, baggage, and other objects).

Specifically, the HUD part 20 includes a HUD housing 21 as its housing, an emitting part 22, a reflection part 23, and a control-circuit board 24. The HUD part 20 reflects the display light emitted from the emitting part 22 on the reflection part 23 toward the windshield WS and causes the windshield WS to reflect the display light toward the eye point EP to display the image 20A on the windshield WS. In the HUD part 20 of the present embodiment, the reflection part 23 includes a first middle mirror 25, a second middle mirror 26, and a last mirror 27. The HUD part 20 reflects the display light emitted from the emitting part 22 via three reflection systems toward the windshield WS. These reflection systems are the first middle mirror 25, the second middle mirror 26, and the last mirror 27, and they constitute the reflection part 23. The HUD part 20 displays the image 20A on an HUD display part WSa of the windshield WS. Typically, the HUD display part WSa is an area predetermined, in the windshield WS, as an area that is easy to be seen from the eye point EP, and composed of a surface on the eye-point-EP side of the windshield WS. In the windshield WS, the HUD display part WSa is provided at a position where the driver DR can view the image 20A displayed on the HUD display part WSa in a condition where he/she is looking ahead in the traveling direction of the vehicle V. For example, the HUD display part WSa is provided at a position where the driver DR can view, in the driver DR's peripheral view, the image 20A displayed on the HUD display part WSa in a condition where he/she is looking straight ahead in the traveling direction of the vehicle V. Without being limited this, the HUD display part WSa may be provided at a position where the driver DR can view, in his/her center view, the image 20A displayed on the HUD display part WSa.

The HUD housing 21 accommodates, in an inner accommodation space 28, the emitting part 22, some of the reflection part 23 (the first middle mirror 25 and the second middle mirror 26 described below), the control-circuit board 24, and other components. For example, the meter housing 11 and the HUD housing 21 described above are individually formed of insulating synthetic resins and other materials to be mutually assembled. For example, the HUD housing 21 is formed into a hollow-box shape by combining a plurality of members, and this hollow-shaped inner space constitutes the accommodation space 28. In the HUD housing 21, an optical-path aperture 21a is formed in the upper surface in the vehicle height direction Z. The optical-path aperture 21a communicates the inside and outside of the HUD housing 21. The optical-path aperture 21a forms an optical-path opening to lead the display light emitted by the emitting part 22 to the outside of the accommodation space 28 of the HUD housing 21. Furthermore, the optical-path aperture 21a leads, to the outside of the accommodation space 28, the display light from the inside of the accommodation space 28 toward the last mirror 27 described below. The optical-path aperture 21a faces the upper side in the vehicle height direction Z. Here, the optical-path aperture 21a of the HUD housing 21 is covered by a clear cover member 21b. The clear cover member 21b is composed of an optically transparent member penetrating at least the display light emitted by the emitting part 22. Furthermore, in the HUD housing 21, a shading wall 21c is stood at an edge on the front side in the vehicle front-back direction X of the optical-path aperture 21a. The shading wall 21c is formed by projecting to the upper side in the vehicle height direction Z and extending along the vehicle width direction Y. In other words, the shading wall 21c is formed, at the edge on the front side in the vehicle front-back direction X of the clear cover member 21b, along a side along the vehicle width direction Y of the clear cover member 21b. The shading wall 21c shades an external light on the front side in vehicle front-back direction X of the clear cover member 21b and prevents the external light from being reflected on the clear cover member 21b. The HUD housing 21 is installed, into the instrument panel IP, in a position relation where it is located between the windshield WS and the meter housing 11 of the meter part 10 in the vehicle front-back direction X and the optical-path aperture 21a faces the upper side in the vehicle height direction Z.

The emitting part 22 is mounted in the vehicle V and has an ability to emit a display light. The emitting part 22 is provided in the accommodation space 28 of the HUD housing 21. The display light emitted by the emitting part 22 is a light that represents the image 20A displayed on the HUD display part WSa of the windshield WS, and includes at least a light of a visible-light-range component. For example, as a device emitting the display light, a thin liquid crystal display, a plasma display, an organic EL display, a light indicator, a fluorescent display tube, and other devices may be used for the emitting part 22. The emitting part 22 is provided, inside the accommodation space 28, at a position on the front side in the vehicle front-back direction X and the lower side in the vehicle height direction Z. The emitting part 22 is supported in the accommodation space 28 such that the optical-axis direction of the emitted display light points to the back side in the vehicle front-back direction X and the upper side in the vehicle height direction Z, and emits the display light toward the back side in the vehicle front-back direction X and the upper side in the vehicle height direction Z.

The reflection part 23 constitutes an optical-path-change optical system to change an optical path of the display light emitted by the emitting part 22. As described above, the reflection part 23 of the present embodiment includes the first middle mirror 25, the second middle mirror 26, and the last mirror 27. The first middle mirror 25 is a first middle mirror totally reflecting the display light emitted from the emitting part 22 toward the second middle mirror 26. The second middle mirror 26 is a second middle mirror totally reflecting the display light emitted from the emitting part 22 and reflected on the first middle mirror 25 toward the last mirror 27. The last mirror 27 is a last-stage mirror totally reflecting the display light emitted from the emitting part 22 and reflected on the first middle mirror 25 and the second middle mirror 26 toward the HUD display part WSa of the windshield WS. The last mirror 27 totally reflects the display light toward the HUD display part WSa of the windshield WS and causes the HUD display part WSa of the windshield WS to reflect the display light toward the eye point EP. Each of the first middle mirror 25, the second middle mirror 26, and the last mirror 27 may be what is called a planar mirror, may be a magnifying mirror, or may be a free-curved mirror. The magnifying mirror is formed as a concave or convex mirror, and magnifies and reflects an image such that an image represented by the display light after reflecting is relatively larger than the image represented by the display light before reflecting. The free-curved mirror is formed as a mirror having an asymmetrical shape to its optical axis unlike a spherical surface and a paraboloid, and is also referred to as a non-spherical mirror. That is, the free-curved mirror is formed as a mirror that is concave or convex and has an asymmetrical shape to its optical axis. The free-curved mirror is formed into a shape corresponding to, for example, the surface shape of the HUD display part WSa and a geometric position relation of the respective optical reflection systems, such as the first middle mirror 25, the second middle mirror 26, and the last mirror 27. When reflecting the display light, the free-curved mirror optically corrects its distortion and reflects it such that the image 20A represented by the display light finally reflected in the HUD display part WSa has a desired shape. In the reflection part 23, the first middle mirror 25 and second middle mirror 26 are configured as free-curved mirrors, and the last mirror 27 is configured as a planar mirror, by way of example.

In the reflection part 23 of the present embodiment, the first middle mirror 25 and the second middle mirror 26 are provided inside the accommodation space 28 of the HUD housing 21 whereas the last mirror 27 is provided outside the accommodation space 28. The first middle mirror 25 is provided, inside the accommodation space 28, at a position on the back side in the vehicle front-back direction X and opposed to the emitting part 22 along the vehicle front-back direction X. The first middle mirror 25 is supported in the accommodation space 28 such that the optical-axis direction of the reflected display light points to the front side in the vehicle front-back direction X and the lower side in the vehicle height direction Z, and reflects the display light toward the front side in the vehicle front-back direction X and the lower side in the vehicle height direction Z. The second middle mirror 26 is provided, inside the accommodation space 28, at a position on the front side in the vehicle front-back direction X and opposed to the first middle mirror 25 along the vehicle front-back direction X. Here, the second middle mirror 26 is provided on the upper side of the emitting part 22 in the vehicle height direction Z. The second middle mirror 26 is supported in the accommodation space 28 such that the optical-axis direction of the reflected display light points to the back side in the vehicle front-back direction X and the upper side in the vehicle height direction Z, and reflects the display light toward the back side in the vehicle front-back direction X and the upper side in the vehicle height direction Z. The display light reflected on the second middle mirror 26 is led from the inside of the accommodation space 28 via the optical-path aperture 21a and the clear cover member 21b to the outside of the accommodation space 28 and goes toward the last mirror 27. Outside the accommodation space 28, the last mirror 27 is located between the windshield WS and the eye point EP in the vehicle front-back direction X and provided at a position opposed to the windshield WS. The last mirror 27 of the present embodiment is located between the windshield WS and the meter housing 11 of the meter part 10 and provided on a back surface 11a of the meter housing 11 of the meter part 10, thereby being provided outside the accommodation space 28 as a whole. Here, in the meter housing 11, the back surface 11a of the meter housing 11 is a surface on the front side in the vehicle front-back direction X and a surface opposite to the meter display part 12. The last mirror 27 is supported on the back surface 11a of the meter housing 11 such that the optical-axis direction of the reflected display light points to the front side in the vehicle front-back direction X and the upper side in the vehicle height direction Z, and reflects the display light toward the front side in the vehicle front-back direction X and the upper side in the vehicle height direction Z. For example, the last mirror 27 reflects the display light incident at an incident angle α toward the HUD display part WSa of the windshield WS at a reflection angle (emitting angle) α. The HUD display part WSa of the windshield WS reflects the display light incident at an incident angle β from the last mirror 27 at a reflection angle (emitting angle) β. For example, the HUD part 20 is configured by appropriately adjusting, with respective parts thereof installed into the instrument panel IP, the angle α and other elements constituting these optical systems such that the display light reflected on the HUD display part WSa reaches the eye point EP. The above configuration of the HUD part 20 may be implemented by adjusting various angles constituting the optical systems of the first middle mirror 25 and the second middle mirror 26.

The control-circuit board 24 is electrically coupled to respective parts of the HUD part 20, including the emitting part 22, and controls the operations of the respective parts of the HUD part 20, including the emitting part 22. Here, the control-circuit board 24 is also electrically coupled to the meter part 10 and also controls the operations of respective parts of the meter part 10. The control-circuit board 24 is also electrically coupled to, for example, a vehicle ECU integrally controlling respective parts of the vehicle V and enables various signals to be mutually transmitted or received. Here, the control-circuit board 24 is illustrated as being accommodated inside the accommodation space 28, but it may be provided inside the accommodation space 28. The control-circuit board 24 may control, along with the HUD part 20, the operation of the whole vehicle display device 1 including the meter part 10.

In the HUD part 20 configured as above, the display light emitted from the emitting part 22 is reflected via the first middle mirror 25 and the second middle mirror 26, which constitute the reflection part 23, toward the last mirror 27. In the HUD part 20, the display light reflected on the second middle mirror 26 reaches the last mirror 27, which constitutes the reflection part 23, via the optical-path aperture 21a and the clear cover member 21b, and is reflected on the last mirror 27 toward the HUD display part WSa of the windshield WS. The display light reflected on the last mirror 27 of the HUD part 20 reaches the HUD display part WSa of the windshield WS and is reflected on the HUD display part WSa toward the eye point EP. This configuration causes the HUD part 20 to display the image 20A by the display light on the HUD display part WSa. The image 20A is a reflection image by the display light reflected on the HUD display part WSa toward the eye point EP and is what is called a virtual image that is visible from the eye point EP. This enables the HUD part 20 to virtually display the image 20A about vehicle information on the HUD display part WSa using the display light.

In the vehicle display device 1 described above, the display light emitted from the emitting part 22 and reflected on the last mirror 27 toward the windshield WS is reflected on the windshield WS toward the eye point EP. This configuration enables the vehicle display device 1 to display the image 20A by the display light on the windshield WS. Here, this vehicle display device 1 performs displaying by the display light on the windshield WS having a rising angle θ on the side of the eye point EP relative to the horizontal direction of equal to or greater than 60° and equal to or less than 90°. In this case, the vehicle display device 1 is disposed in a geometric position relation where the last mirror 27 is provided outside the accommodation space 28 as a whole, and is located between the windshield WS and the eye point EP in the vehicle front-back direction X and opposed to the windshield WS. The vehicle display device 1 in this configuration allows the display light to be incident to the windshield WS having the rising angle θ as described above at an appropriate angle, while being disposed in a limited space between the windshield WS and the eye point EP. This enables the vehicle display device 1 to virtually display the image 20A by the display light appropriately on the windshield WS having the rising angle θ as described above so as to be visible from the eye point EP. This enables the vehicle display device 1 to display the image 20A by the display light appropriately on the windshield WS rising from the horizontal direction.

Furthermore, the last mirror 27 of the vehicle display device 1 described above is located between the windshield WS and the meter part 10 in the vehicle front-back direction X and provided on the back surface 11a, which is the surface on the front side in the vehicle front-back direction X of the meter part 10. This configuration enables the vehicle display device 1 to display the image 20A by the display light appropriately on the windshield WS, while a dead space between the windshield WS and the meter part 10 is effectively utilized for disposing last mirror 27. This enables the vehicle display device 1 to be compactly configured as a whole, for example, by reducing a part projecting toward the driver DR as much as possible. Furthermore, the meter part 10 and the HUD part 20 are integrated and unitized to be collectively mounted in the vehicle V. This allows the mountability of the vehicle display device 1 to be improved.

More particularly, the vehicle display device 1 described above is disposed in a geometric position relation where the last mirror 27 is located between the windshield WS and the eye point EP in the vehicle front-back direction X and opposed to the windshield WS, and reflects the display light emitted from the emitting part 22 toward the front side of the vehicle front-back direction X. The vehicle display device 1 in this configuration can have a layout where it is disposed at a position that is hard to interfere with operations by the driver DR and other occupants, while virtually displaying the image 20A by the display light on the windshield WS having the rising angle θ as described above.

### Second Embodiment

The vehicle display device according to a second embodiment is different from that of the first embodiment in that it includes a display-position adjuster. Hereinafter, the common number is given to the same component as that of the embodiment described above, and the redundant description about the common configuration, action, and effect is omitted as much as possible (the same hereinafter).

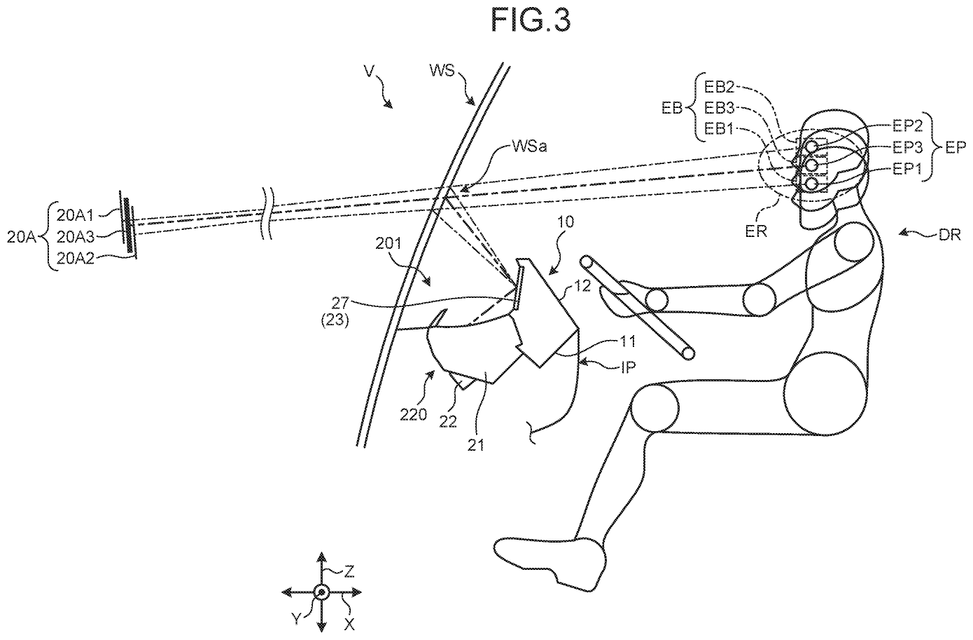

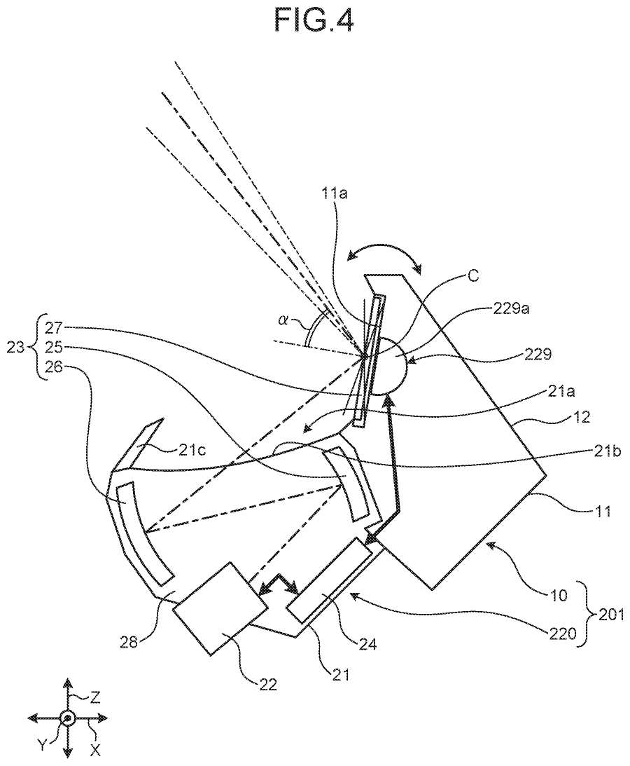

A vehicle display device 201 according to the present embodiment shown in FIG. 3 and FIG. 4 is different from the vehicle display device 1 described above in that it includes an HUD part 220 instead of the HUD part 20, and any other configurations are substantially the same as those of the vehicle display device 1. The HUD part 220 is different from the HUD part 20 described above in that it includes a display-position adjuster 229, and any other configurations are substantially the same configuration as those of the HUD part 20.

The display-position adjuster 229 is a mechanism that can adjust a display position of the image 20A by the display light reflected on the HUD display part WSa of the windshield WS toward the eye point EP. The eye box EB and the eye point EP assumed in the vehicle V fluctuates along the vehicle height direction Z depending on, for example, the physical constitution and posture of the driver DR, and the height of the seating face of a seat where the driver DR is sitting. In response to this, the display-position adjuster 229 adjusts the display position of the image 20A by the display light such that this display position is appropriately located depending on fluctuations of the eye box EB and the eye point EP along the vehicle height direction Z.

Specifically, the display-position adjuster 229 rotates the last mirror 27, around a rotary-axis line C along the vehicle width direction Y as the rotation center, to adjust a reflection angle α of the display light reflected on the last mirror 27 toward the windshield WS. This configuration enables the display-position adjuster 229 to adjust the display position of the image 20A by the display light reflected on the HUD display part WSa of the windshield WS toward the eye point EP.

The display-position adjuster 229 of the present embodiment has a drive actuator 229a provided on a surface on the back side in the vehicle front-back direction X of the last mirror 27. The drive actuator 229a includes a motor and other components and rotates, by driving the motor, the last mirror 27 around the rotary-axis line C set to the vicinity of the last mirror 27. The display-position adjuster 229 allows the reflection angle α to be variable by rotating the last mirror 27 around the rotary-axis line C with the drive actuator 229a.

The display-position adjuster 229 rotates the last mirror 27 around the rotary-axis line C to relatively increase the reflection angle α, for example, when the eye box EB and the eye point EP are located on the relatively lower side in the vehicle width direction Y (see an eye box EB1 and an eye point EP1 in FIG. 3). Thus, the display-position adjuster 229 causes the display position of the image 20A by the display light to be located on the relatively upper side in the vehicle width direction Y (see an image 20A1 in FIG. 3). In contrast, the display-position adjuster 229 rotates the last mirror 27 around the rotary-axis line C to relatively decrease the reflection angle α, for example, when the eye box EB and the eye point EP are located on the relatively upper side in the vehicle width direction Y (see an eye box EB2 and an eye point EP2 in FIG. 3). Thus, the display-position adjuster 229 causes the display position of the image 20A by the display light to be located on the relatively lower side in the vehicle width direction Y (see an image 20A2 in FIG. 3). The display-position adjuster 229 rotates the last mirror 27 around the rotary-axis line C to cause the reflection angle α to be an angle between the above angles, for example, when the eye box EB and the eye point EP are located between the above positions in the vehicle width direction Y (see an eye box EB3 and an eye point EP3 in FIG. 3). Thus, the display-position adjuster 229 causes the display position of the image 20A by the display light to be located between the above positions in the vehicle width direction Y (see an image 20A3 in FIG. 3).

The display-position adjuster 229 is electrically coupled to the control-circuit board 24, and its operation is controlled. The control-circuit board 24 may control the display-position adjuster 229, for example, based on an operation input to an operating part by the driver DR and other occupants, to adjust the reflection angle α of the last mirror 27 and adjust the display position of the image 20A by the display light. Otherwise, the control-circuit board 24 may control the display-position adjuster 229, for example, based on a detection result by a detector detecting the eye point EP of the driver DR, to automatically adjust the reflection angle α of the last mirror 27 and automatically adjust the display position of the image 20A by the display light.

The vehicle display device 201 described above can display the image 20A by the display light appropriately on the windshield WS rising from the horizontal direction.

The vehicle display device 201 described above can rotate the last mirror 27 around the rotation-axis line C with the display-position adjuster 229 to adjust the reflection angle α, thereby adjusting, to an appropriate position, the display position of the image 20A by the display light reflected on the HUD display part WSa of the windshield WS toward the eye point EP.

In this case, the display-position adjuster 229 adjusts the reflection angle α of the last mirror 27 of a plurality of reflection systems constituting the reflection part 23 (the first middle mirror 25, the second middle mirror 26, and the last mirror 27). This configuration enables the display-position adjuster 229 to adjust the reflection angle α of the last mirror 27, which is closer to the HUD display part WSa of the windshield WS, and thus adjust, to an appropriate position, the display position of the image 20A by the display light while the adjustment width of the reflection angle α is reduced to be relatively small. This enables the vehicle display device 201 to display the image 20A by the display light appropriately on the windshield WS rising from the horizontal direction.

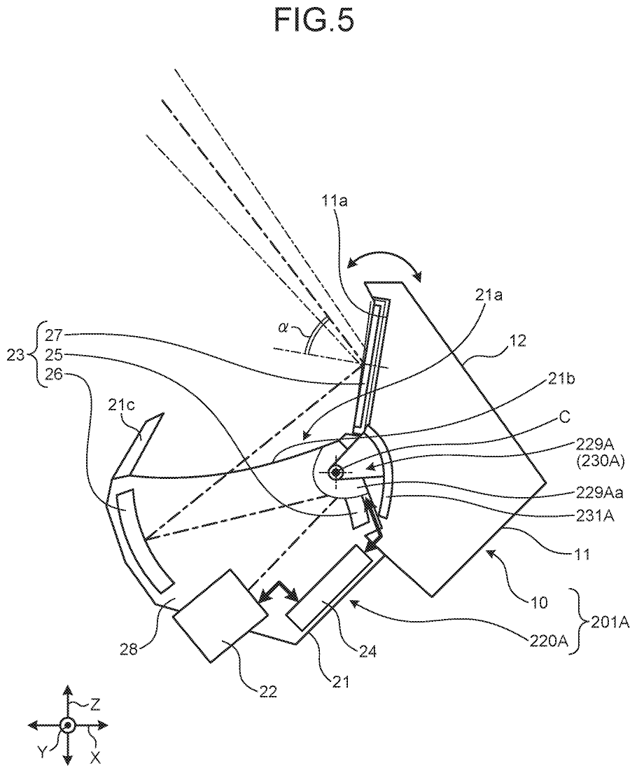

Note that the display-position adjuster 229 described above is not limited to the above configuration. A vehicle display device 201A according to a variation shown in FIG. 5 includes an HUD part 220A. This HUD part is different from the HUD part 220 described above in that it includes a display-position adjuster 229A instead of the display-position adjuster 229, and any other configurations are substantially the same as those of the HUD part 220. The display-position adjuster 229A has a drive actuator 229Aa provided on an end on the lower side in the vehicle height direction Z of the last mirror 27. The drive actuator 229Aa includes a motor and other components and rotates, by driving the motor, the last mirror 27 around the rotary-axis line C, which is set to the end on the lower side in the vehicle height direction Z of the last mirror 27. The display-position adjuster 229A allows the reflection angle α to be variable by rotating the last mirror 27 around the rotary-axis line C with the drive actuator 229Aa. This configuration enables the display-position adjuster 229A to adjust the display position of the image 20A by the display light reflected on the HUD display part WSa of the windshield WS toward the eye point EP. This case also enables the vehicle display device 201A to adjust, to an appropriate position, the display position of the image 20A by the display light reflected on the HUD display part WSa of the windshield WS toward the eye point EP.

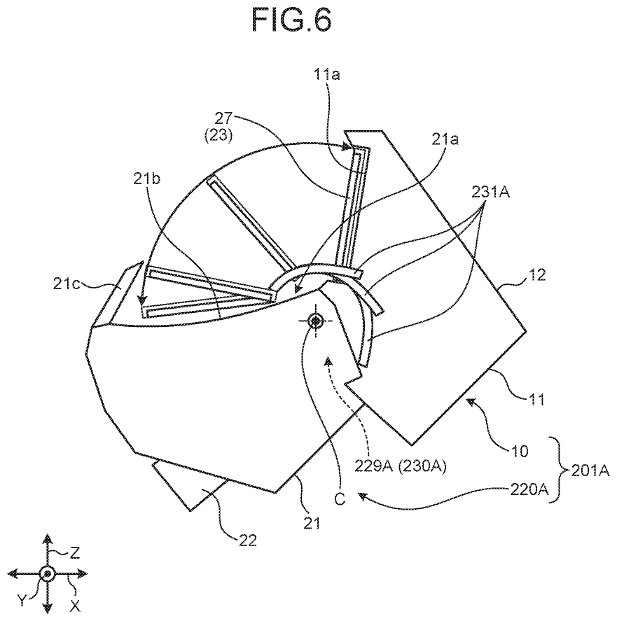

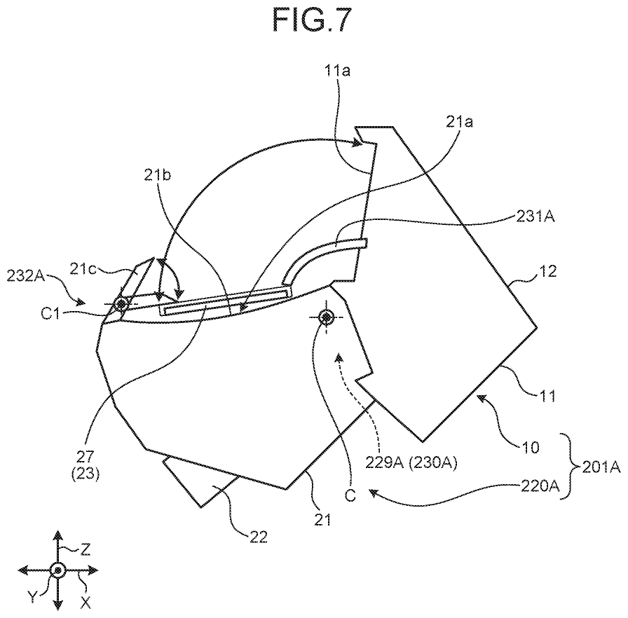

In this case, the display-position adjuster 229A can be also shared as an aperture-opening/closing driver 230A to open and close the optical-path aperture 21a formed in the HUD housing 21. The Display-position adjuster 229A shared as the aperture-opening/closing driver 230A rotates the last mirror 27 around the rotary-axis line C as the rotation center, thereby allowing this mirror to move to the display position shown in FIG. 5 and FIG. 6 as well as a non-display position shown in FIG. 6 and FIG. 7. The display position of the last mirror 27, at which the optical-path aperture 21a formed in the HUD housing 21 is opened, is a position where the last mirror 27 is located between the windshield WS and the eye point EP in the vehicle front-back direction X and opposed to the windshield WS, as described above. The display position is a position where the last mirror 27 reflects the display light emitted from the emitting part 22 toward the windshield WS on the front side in the vehicle front-back direction X and causes the windshield WS to reflect the display light toward the eye point EP to display the image 20A (see FIG. 3 and other figures). In contrast, the non-display position of the last mirror 27 is a position where the last mirror 27 blocks the optical-path aperture 21a formed in the HUD housing 21. The non-display position is a position where the windshield WS fails to display the image 20A (see FIG. 3 and other figures).

The display-position adjuster 229A shared as the aperture-opening/closing driver 230A is electrically coupled to the control-circuit board 24, and its operation is controlled. When the image 20A by the display light is displayed, the control-circuit board 24 controls the display-position adjuster 229A shared as the aperture-opening/closing driver 230A and causes the last mirror 27 to be at the display position. In contrast, when the image 20A by the display light is non-displayed, the control-circuit board 24 controls the display-position adjuster 229A shared as the aperture-opening/closing driver 230A and causes the last mirror 27 to be at the non-display position.

The vehicle display device 201A according to the variation described above causes the last mirror 27 to be at the display position with the display-position adjuster 229A shared as the aperture-opening/closing driver 230A, thereby displaying the image 20A by the display light. In contrast, the vehicle display device 201A causes the last mirror 27 to be at the non-display position with the display-position adjuster 229A shared as the aperture-opening/closing driver 230A, thereby allowing the last mirror 27 to function as a cover of the optical-path aperture 21a. As a result, the vehicle display device 201A allows the last mirror 27 to function as the cover of the optical-path aperture 21a when non-displaying the image 20A by the display light, thereby preventing, for example, an intrusion of foreign objects and a deposition of dust into the HUD housing 21 through the optical-path aperture 21a.

In this case, the HUD part 220A of the vehicle display device 201A may further include a cover member 231A. As shown in FIG. 5 and FIG. 6, this cover member is provided around the rotary-axis line C and rotates together with the last mirror 27 while the last mirror 27 rotates. The cover member 231A blocks a gap near the rotary-axis line C of the optical-path aperture 21a with the last mirror 27 at the non-display position and, on the other hand, opens the gap with the last mirror 27 at the display position. This configuration enables the vehicle display device 201A to surely prevent, for example, an intrusion of foreign objects and a deposition of dust into the HUD housing 21 through the optical-path aperture 21a.

In this case, the HUD part 220A of the vehicle display device 201A may further include a drive actuator 232A. As shown in FIG. 7, this actuator can move the shading wall 21c to its standing position and blocking position by rotating it around the rotary-axis line C1 along the vehicle width direction Y as the rotation center. As with the drive actuators 229a, 229Aa, and others, the drive actuator 232A includes a motor and other components and rotates, by driving the motor, the shading wall 21c around the rotary-axis line C1, which is set to an end on the lower side in the vehicle height direction Z of the shading wall 21c. The standing position of the shading wall 21c is a position where the shading wall 21c projects to the upper side in the vehicle height direction Z, shades an external light on the clear cover member 21b, and prevents the external light from being reflected on the clear cover member 21b. In contrast, the blocking position of the shading wall 21c is a position where the shading wall 21c blocks a gap opposed to the side of the rotary-axis line C of the optical-path aperture 21a. The drive actuator 232A is electrically coupled to the control-circuit board 24, and its operation is controlled. When the last mirror 27 is at the display position, the control-circuit board 24 controls the drive actuator 232A and causes the shading wall 21c to be at the standing position. In contrast, when the last mirror 27 is at the non-display position, the control-circuit board 24 controls the drive actuator 232A and causes the shading wall 21c to be at the blocking position. This configuration enables the vehicle display device 201A to more surely prevent, for example, an intrusion of foreign objects and a deposition of dust into the HUD housing 21 through the optical-path aperture 21a. Note that the vehicle display devices according to the embodiments and the variation of the present invention described above are not limited the embodiments and the variation described above, and various changes are possible within the scope of the claims. The vehicle display device according to the present embodiments and the variation may be configured by combining the components of the respective embodiments and variation described above as necessary.

The vehicle display devices 1, 201, and 201A described above exhibit their effect more suitably if they are applied to the vehicle V where the rising angle θ of the windshield WS is equal to or greater than 70° and equal to or less than 90° (70°≤θ≤90°), and furthermore the rising angle θ is equal to or greater than 80° and equal to or less than 90° (80°≤θ≤90°).

In the following description, the vehicle display devices 1, 201, and 201A are described as the display device unit where the meter part 10 and the HUD parts 20, 220, and 220A are integrated and unitized, but are not limited to this. The vehicle display devices 1, 201, and 201A may be configured with the HUD parts 20, 220, and 220A only, without including the meter part 10.

In the following description, the HUD parts 20, 220, and 220A are described as those where the reflection part 23 includes the first middle mirror 25, the second middle mirror 26, and the last mirror 27, but are not limited to this. The HUD parts 20, 220, and 220A may include at least the last mirror 27 and omit the first middle mirror 25 and the second middle mirror 26, or otherwise, may include three or more mirrors.

In the following description, the last mirror 27 is described as that located between the windshield WS and the meter housing 11 of the meter part 10 and provided on the back surface 11a of the meter housing 11 of the meter part 10, but is not limited this. The last mirror 27 may be provided on any other regions other than the back surface 11a as long as it is provided outside the accommodation space 28 as a whole.

In the following description, the display-position adjuster 229A is described as that shared as the aperture-opening/closing driver 230A, but is not limited to this. The display-position adjuster 229A and the aperture-opening/closing driver 230A may be configured separately.

The vehicle display device according to the present embodiment enables the windshield to reflect, toward the eye point, the display light emitted from the emitting part and reflected on the last mirror toward the windshield, to perform displaying by the display light on the windshield. This vehicle display device performs displaying by the display light on the windshield having a rising angle on the side of the eye point relative to a horizontal direction of equal to or greater than 60° and equal to or less than 90°. In this case, the vehicle display device is disposed in a geometric position relation where the last mirror is provided outside the accommodation space as a whole, and is located between the windshield and the eye point in the vehicle front-back direction and opposed to the windshield. This configuration enables the vehicle display device to perform displaying by the display light appropriately on the windshield having the rising angle as described above so as to be visible from the eye point. As a result, the vehicle display device exhibits its effect of performing displaying by the display light appropriately on the windshield rising from the horizontal direction.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
an emitting part that is mounted in a vehicle and emits a display light;
a housing that accommodates the emitting part in an inner accommodation space; and
a last mirror that reflects the display light emitted from the emitting part toward a windshield provided in a front of the vehicle in a vehicle front-back direction and causes the windshield to reflect the display light toward an presumed eye point, wherein
the last mirror is provided outside the accommodation space as a whole, and is located between the windshield and the eye point in the vehicle front-back direction and opposed to the windshield,
the housing has an optical-path aperture that leads, to an outside of the accommodation space, the display light from an inside of the accommodation space toward the last mirror, and
the vehicle display device further comprises:
an aperture-opening/closing driver that allows the last mirror to move to a display position where the last mirror is located between the windshield and the eye point and opposed to the windshield in the vehicle front-back direction, reflects the display light emitted from the emitting part toward the windshield on the front side in the vehicle front-back direction, and causes the windshield to reflect the display light toward the eye point, and a non-display position where the last mirror blocks the optical-path aperture.

2. The vehicle display device according to claim 1, further comprising:
a meter part that is located between the windshield and the eye point in the vehicle front-back direction and displays vehicle information about the vehicle visibly at the eye point, wherein
the last mirror is located between the windshield and the meter part in the vehicle front-back direction and provided on a surface on the front side in the vehicle front-back direction of the meter part.

3. The vehicle display device according to claim 1, wherein
the windshield has a rising angle on a side of the eye point relative to a horizontal direction of equal to or greater than 60° and equal to or less than 90°.

4. The vehicle display device according to claim 2, wherein
the windshield has a rising angle on a side of the eye point relative to a horizontal direction of equal to or greater than 60° and equal to or less than 90°.

5. The vehicle display device according to claim 1, further comprising:
a display-position adjuster that rotates the last mirror, around a rotary-axis line along a vehicle width direction crossing the vehicle front-back direction as a rotation center, to adjust a reflection angle of the display light reflected on the last mirror toward the windshield and adjust a display position by the display light reflected on the windshield toward the eye point.

6. The vehicle display device according to claim 2, further comprising:
a display-position adjuster that rotates the last mirror, around a rotary-axis line along a vehicle width direction crossing the vehicle front-back direction as a rotation center, to adjust a reflection angle of the display light reflected on the last mirror toward the windshield and adjust a display position by the display light reflected on the windshield toward the eye point.

7. The vehicle display device according to claim 3, further comprising:
a display-position adjuster that rotates the last mirror, around a rotary-axis line along a vehicle width direction crossing the vehicle front-back direction as a rotation center, to adjust a reflection angle of the display light reflected on the last mirror toward the windshield and adjust a display position by the display light reflected on the windshield toward the eye point.

8. The vehicle display device according to claim 4, further comprising:
a display-position adjuster that rotates the last mirror, around a rotary-axis line along a vehicle width direction crossing the vehicle front-back direction as a rotation center, to adjust a reflection angle of the display light reflected on the last mirror toward the windshield and adjust a display position by the display light reflected on the windshield toward the eye point.

9. The vehicle display device according to claim 1, wherein
the last mirror reflects the display light emitted from the emitting part toward the front side in the vehicle front-back direction.

10. The vehicle display device according to claim 2, wherein
the last mirror reflects the display light emitted from the emitting part toward the front side in the vehicle front-back direction.

11. The vehicle display device according to claim 3, wherein
the last mirror reflects the display light emitted from the emitting part toward the front side in the vehicle front-back direction.

12. The vehicle display device according to claim 4, wherein
the last mirror reflects the display light emitted from the emitting part toward the front side in the vehicle front-back direction.

13. The vehicle display device according to claim 5, wherein
the last mirror reflects the display light emitted from the emitting part toward the front side in the vehicle front-back direction.

14. The vehicle display device according to claim 6, wherein
the last mirror reflects the display light emitted from the emitting part toward the front side in the vehicle front-back direction.

15. The vehicle display device according to claim 7, wherein
the last mirror reflects the display light emitted from the emitting part toward the front side in the vehicle front-back direction.

16. The vehicle display device according to claim 8, wherein
the last mirror reflects the display light emitted from the emitting part toward the front side in the vehicle front-back direction.
